(19) United States
(12) Patent Application Publication
(10) Pub. No.: US 2017/0186114 A1
(43) Pub. Date: Jun. 29, 2017

(54) Systems and Methods for Use in Identifying Effective Purchase Options for Travel

(71) Applicant: MASTERCARD INTERNATIONAL INCORPORATED, Purchase, NY (US)

(72) Inventors: Lisa Bongiovi, Howard Beach, NY (US); Malavika Singh, New York, NY (US); Michael J. Friedman, Standford, CT (US); Kimberly Purcell, Wilton, CT (US)

(21) Appl. No.: 14/982,536

(22) Filed: Dec. 29, 2015

(51) Int. Cl. G06Q 50/14; G06Q 10/10; G06Q 10/02

(52) U.S. Cl. CPC G06Q 50/14; G06Q 10/02; G06Q 10/1095

(57) ABSTRACT

Systems and methods are provided for identifying effective purchase options for travel. One exemplary method includes accessing, by a computing device, calendar data for a user including a location and a time for an appointment; identifying, by the computing device, a first purchase option including travel from a prior location to the appointment location, so that the user is scheduled to arrive at the location of the appointment prior to the appointment time; identifying, by the computing device, a second purchase option including travel, different than the travel of the first purchase option, from the prior location to the location of the at least one appointment; determining, by the computing device, a fare associated with each of the purchase options; receiving, at the computing device, a selection of at least one of the purchase options; and publishing, by the computing device, the selected at least one of the purchase options.

### FIELD

The present disclosure generally relates to systems and methods for identifying effective purchase options for travel and, in particular, for identifying particular purchase options for users based on calendar data for the users, to permit the users to travel as indicated by their calendar data.

### BACKGROUND

This section provides background information related to the present disclosure which is not necessarily prior art.

Consumers use payment accounts to purchase various different products and services including, for example, transit products and services. Often, in anticipation of travel, or at the time of travel, the consumers use their payment accounts to purchase rides for trains, planes, taxi cabs, etc., to reach one or more desired locations. The rides may be purchased as individual or one-time rides (e.g., taxi cab rides), as multiple specific rides (e.g., roundtrip airline tickets), or as interval rides (e.g., 30-day passes for buses or trains). Prior to making the purchases, schedules and costs (or fares) for various ride options are investigated by the consumers and compared with their travel plans, prior to purchase.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in identifying purchase options for travel by consumers, based on calendar data for the consumers;

FIG. 2 is a block diagram of a computing device, that may be used in the exemplary system of FIG. 1;

FIG. 3 is an exemplary method for identifying purchase options, for a consumer, for travel by the consumer based on calendar data for the consumer that may be implemented in the system of FIG. 1; and

FIGS. 4 and 5 are exemplary interfaces, which may be displayed to a consumer, in connection with the system of FIG. 1 and/or the method of FIG. 3.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Options for travel to desired locations are often identified and purchased by consumers (broadly, users), when needed. However, the consumers typically don't consider (or aren't able to consider) all available options before making their purchases. The systems and methods herein provide automated identification of multiple purchase options for consumers and permit the consumers to select ones of the options that most closely meet their travel needs, with the different options having different parameters and associated costs (or fares) for reaching desired locations. In particular, calendar data for the consumers is used to determine travel requirements for the consumers, and the travel requirements are then compared to available travel schedules to identify available purchase options, for example, to locations associated with appointments on the consumers' calendars, etc. The purchase options may also be filtered based on travel preferences for the consumers and/or other rules, and then displayed to the consumers for review. Upon selection of particular ones of the purchase options by the consumers, the systems and methods herein may further facilitate purchases of products and/or services associated with the selected options from transit merchants, through use of payment accounts associated with the consumers.

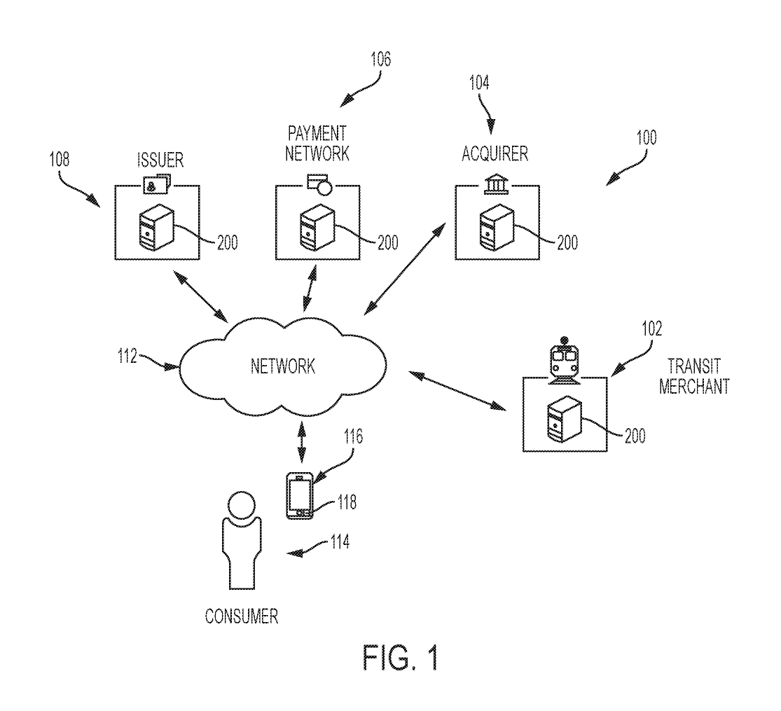

FIG. 1 illustrates an exemplary system 100, in which the one or more aspects of the present disclosure may be implemented. Although the system 100 is presented in one arrangement, other embodiments may include systems arranged otherwise depending, for example, on accessibility of transit data, accessibility of consumer calendar data, processing of purchase options for travel, etc.

The system 100 generally includes a transit merchant 102, an acquirer 104, a payment network 106, and an issuer 108, each coupled to network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which is accessible as desired to the merchant 102, the acquirer 104, the payment network 106, the issuer 108, and consumer 114.

The transit merchant 102 is generally associated with travel services, and transport of consumers from one location to another. Specifically, in this exemplary embodiment, the transit merchant 102 is associated with train travel (e.g., travel by train, subway, tram, streetcar, trolley, metro, etc.) in one or more regions. Nonetheless, in other embodiments, transit merchants (and merchants in general) may be associated with various different types of travel and/or non-travel related products and/or services. Further, while only one transit merchant 102 is shown in FIG. 1, it should be understood that other embodiments may include multiple transit merchants, and/or may include one or more different types of merchants offering a variety of different products and/or services, which may, for example, be purchased at regular or irregular intervals in accordance with the present disclosure (i.e., products and services not specifically limited to travel).

In the system 100, the transit merchant 102 provides options for travel to consumer 114 (broadly, a user) and other consumers, according to one or more schedules (although use of such schedules is not required). Desired travel according to one or more of the options, and more particularly passes for such travel, can be purchased by the consumer 114 in exchange for a fare, which is often per ride or per interval. For example, the transit merchant 102 may provide daily, weekly, or monthly passes, or different interval passes, or passes for 5 rides, 10 rides, 30, rides, or a different number of rides, etc. Often, the per-interval fares vary depending on the number of rides the passes cover. For example, a daily pass (with unlimited rides for one day) may cost $8.00, while a weekly pass (with unlimited rides for one week) may cost $35.00. And, a 10-ride pass may cost $50.00, while a 25-ride pass may cost $100.00. It should be appreciated that a variety of different passes may be provided by the transit merchant 102, indicative of a variety of different numbers of rides and/or intervals, etc.

The one or more schedules associated with the options for travel provided by the transit merchant 102 can be made available in different manners. For example, the transit merchant 102 may provide a website, or an application, or an application programming interface (API), through which the schedules and corresponding fares (broadly, transit data) may be accessed and/or retrieved by the consumer 114 via portable communication device 116 (and by other consumers in a similar manner). In various embodiments, the transit merchant 102 further offers, through the website, or the application, or the API, the ability to purchase a pass for a selected option (or passes for multiple selected options). In particular, a web-based interface, associated with the transit merchant's website, or application, may solicit information about the consumer 114, including payment information, and then may permit/facilitate a purchase transaction for the pass. Once the purchase transaction is completed, the purchased pass may be delivered to the consumer 114, by the transit merchant 102, via mail or electronically, as desired.

With continued reference to FIG. 1, the consumer 114 is associated with a payment account (or with multiple payment accounts) through which the consumer 114 may complete a purchase transaction for the travel from the transit merchant 102 (e.g., for a pass associated with the selected travel, etc.). The consumer 114 may initiate the purchase transaction by providing details of his/her payment account (e.g., a payment account number, etc.) to the transit merchant 102 via the web-based interface associated with the transit merchant's website, or application. Or, the consumer 114 may present a payment device associated with his/her payment account, such as a credit card, a debit card, a pre-paid card, a payment fob, the communication device 116 with a payment account application (e.g., an e-wallet application, etc.), etc., to the transit merchant 102 at a physical location of the transit merchant 102.

In any case, upon receiving payment information from the consumer 114 for the selected travel, the transit merchant 102 communicates an authorization request to the acquirer 104 identifying, for example, a payment account number for the transaction and an amount of the purchase. The acquirer 104, in turn, communicates the authorization request to the issuer 108, through the payment network 106, such as, for example, through MasterCard®, VISA®, Discover®, American Express®, etc., to determine (in conjunction with the issuer 108 that provided the payment account to the consumer 114) whether the payment account is in good standing and whether there is sufficient credit or funds to complete the transaction. If the issuer 108 accepts the transaction, a reply authorizing the transaction is provided back to the acquirer 104 and the transit merchant 102, thereby permitting the transit merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108). If the issuer 108 declines the transaction, a reply declining the transaction is provided back to the transit merchant 102, thereby permitting the merchant 102 to stop the transaction.

The above transaction is described with reference to a credit account. However, it should be appreciated that purchase transactions may further include other transactions, such as debit transactions and pre-paid transactions. For debit and pre-paid accounts, a transaction, and processing thereof, is substantially similar to the above transaction, but may further include the use of a personal identification number (PIN) authorization and/or more rapid posting of the charge to the payment account, etc.

Transaction data is generated, collected, and stored as part of the above interactions among the transit merchant 102, the acquirer 104, the payment network 106, the issuer 108, and the consumer 114. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the transit merchant 102, the acquirer 104 and/or the issuer 108 may store the transaction data, or part thereof, in a data structure, or transaction data may be transmitted between parts of system 100, as used or needed. The transaction data includes, for example, payment account numbers, amounts of the transactions, merchant IDs, merchant category codes (MCCs), dates/times of the transactions, products purchased and related descriptions or identifiers, etc. It should be appreciated that more or less information related to transactions, as part of either authorization and/or clearing and/or settling, may be included in transaction data and stored within the system 100, at the transit merchant 102, the acquirer 104, the payment network 106, and/or the issuer 108.

In various exemplary embodiments, the consumers involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions, subsequently for one or more of the different purposes described herein. Enrollment can be carried out in a variety of ways; for example, through a web interface, an application store, and/or a credit account issuer or other financial institution. There may be some payment data that will not be shared even if the consumer does consent (e.g., health care transactions, etc.), for example, when it is against policy or otherwise inappropriate. The consumer may be afforded many options but some may be restricted for legal or policy reasons or the like (yet, appropriate age limits are preferably enforced on those enrolling). That is, there is preferably no sharing without the consumer's consent, and some data may not be appropriate to share even with the consumer's consent.

Further, appropriate usage limits are preferably placed on use of the publication, dissemination, and/or sharing of the data. Of course, all applicable laws, rules, regulations, policies and procedures with respect to age of consumers, privacy, and the like will always be fully complied with.

While one acquirer 104, one payment network 106, one issuer 108, and one consumer 114 are illustrated in FIG. 1, it should be appreciated that any number of these entities (and their associated components) may be included in the system 100, or may be included as a part of systems in other embodiments, consistent with the present disclosure.

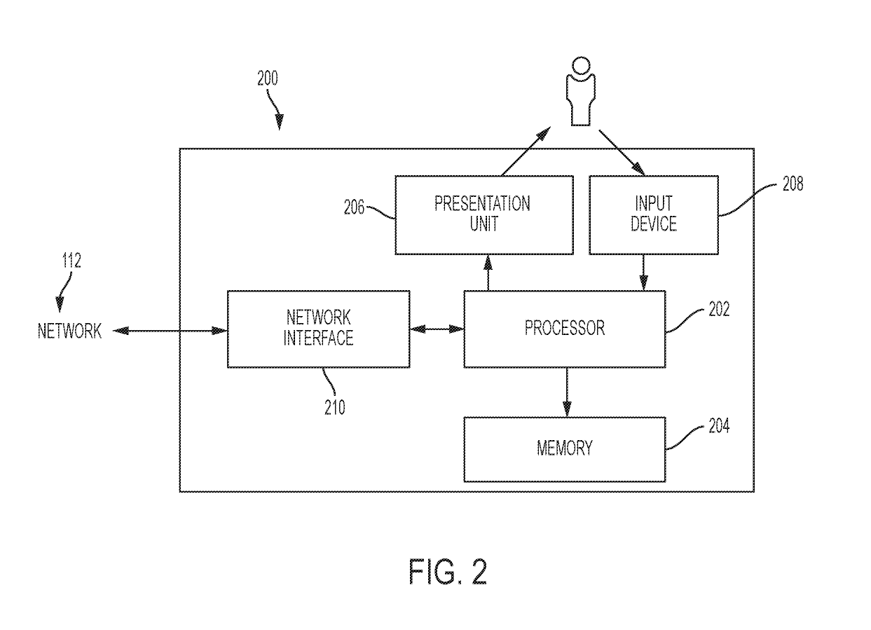

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the transit merchant 102, the acquirer 104, the payment network 106, and the issuer 108 are illustrated as including, or being implemented in, computing device 200, coupled to the network 112. Further, the computing devices 200 associated with these entities, for example, may include a single computing device, or multiple computing devices located in close proximity or distributed over a geographic region. In addition, the portable communication device 116, associated with consumer 114, can also be considered a computing device consistent with computing device 200 for purposes of the description herein. Further, while not shown, the transit merchant 102 may also include one or more point of sale (POS) terminals configured for processing payment devices in connection with purchase transactions for travel (e.g., for travel passes, etc.), where the POS devices are also consistent with computing device 200.

Referring to FIG. 2, the exemplary computing device 200 includes a processor 202 and a memory 204 coupled to the processor 202. The processor 202 may include one or more processing units (e.g., in a multi-core configuration, etc.). For example, the processor 202 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, transit data (e.g., transit schedules (e.g., times, origins, destinations, etc.), transit routes, transit passes and related details, transit fares (e.g., pricing for each of the different passes, etc.), etc.), user preferences, payment account information and credentials, calendar data, weather information, traffic information, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is identifying and/or presenting purchase options to the consumer 114. It should be appreciated that the memory 204 may include a variety of different memories, each implemented in one or more of the functions or processes described herein.

In the exemplary embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., purchase options for passes by cost and/or by route, purchased passes, etc.), either visually or audibly to a user of the computing device 200, for example, the consumer 114 in the system 100, etc. It should be further appreciated that various interfaces (e.g., application interfaces, webpages, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, entries of user preferences, selections of purchase options for travel, payment information, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202.

In various embodiments herein, the input device 208 and/or the network interface 210 of the computing device 200 may include, among other things, a GPS antenna suitable to capture GPS signals for processing by the processor 202 to determine a location of the computing device 200.

Referring again to FIG. 1, the consumer's portable communication device 116 includes calendar data associated with the consumer 114. The calendar data may be stored in memory 204 of the portable communication device 116. Or, the portable communication device 116 may include a calendar application, stored in part or in total in memory 204 of the portable communication device 116 or in a companion computing device, associated with calendar and/or email features of the portable communication device 116 (e.g., Outlook® manager, or other personal information manager, etc.).

The calendar data often includes multiple appointments for the consumer 114, as well as times, dates, and locations of the appointments. As an example, such an appointment may include a particular meeting or event that the consumer 114 plans to attend at a particular address and time, and may be business or personal in nature (e.g., a business meeting, a client presentation, an exercise class, a doctor's appointment, a work-related training session, etc.). Or, the appointment may simply include a scheduled workday in the office (e.g., a scheduled arrival and/or departure time to/from work, etc.), and/or a scheduled time at home after work, etc. Basically, an appointment may be understood, as used herein, to be any occasion or event for the consumer 114 to be at a particular location at a particular time. The calendar data may also include information about the consumer 114 such as contact information, payment account information, etc., and his/her general schedule including the appointments, identities of persons attending the appointments, contact information for such persons, and/or descriptions of the purposes and/or content of the appointments, etc.

In addition, the calendar data may include various default locations and times, where the consumer 114 is typically present at particular times. For example, when the consumer is employed at 123 Main St., i.e., the consumer's work location, it may be a default in the calendar data that the consumer 114 will be at 123 Main St. each work day (e.g., Monday through Friday, etc.) for a duration of the work day (e.g., from 9 am to 5 pm, etc.). It may also be a default in the calendar data that, in the morning before work, the consumer 114 will be at a home location and will be traveling to the work location from his/her home location and that, in the evening after work, the consumer 114 will be traveling from the work location back to his/her home location (as indicated by a typical workday schedule). Appointments added to the consumer's calendar may then be understood to be modifications to these default entries.

With further reference to FIG. 1, the communication device 116, associated with the consumer 114, includes a selection engine 118 that is specifically configured, often by executable instructions, to perform one or more of the various features described herein. While the selection engine 118 is shown incorporated in the communication device 116 in FIG. 1, it should be appreciated that in other embodiments the selection engine 118 may be included in other parts of the system 100 (e.g., in the transit merchant 102, in the payment network 106, etc.), or it may be a standalone part.

In particular in the system 100, the engine 118 is configured to access the calendar data for the consumer 114, at the portable communication device 116, by interfacing a personal information manager (in the portable communication device 116, or elsewhere), in which the calendar data is entered and/or stored. In various embodiments, the consumer 114 may provide permission to the engine 118 to access the calendar data, for example, at registration for use of the engine 118, at the outset to each use of the engine 118 (e.g., via an appropriate interface, etc.), etc.

Calendar data for a desired time interval such as a week, a month, etc., may be accessed by the engine 118, depending, for example, on a preference of the consumer 114 in how far forward the consumer 114 is wanting to purchase travel or view purchase options for travel, or depending on transaction data indicating the interval at which the consumer 114 purchases travel, etc. As an example, the consumer 114 may have a consistent schedule over the next 30 days, with little or no variations. As such, the consumer 114 may be interested (as indicated by a user preference or otherwise) in purchasing travel passes from the transit merchant 102 over a long term so that he/she does not have to continually repurchase travel. As another example, the consumer 114 may typically have frequent rearrangements of his/her schedule, with meetings or other appointments frequently added, removed, or rescheduled. As such, in this example, the consumer 114 may only be interested in purchasing travel passes for one day, or for one ride, at a time (to provide travel flexibility in accordance with his/her schedule).

The engine 118 is also configured to access transit data (broadly, travel data) at the transit merchant 102, for example, stored in a data structure in memory 204, etc. The transit data may include various data associated with purchase options provided by the transit merchant 102 such as, for example, transit schedules (e.g., times, origins, destinations, etc.), transit routes (and maps), transit passes and related details, transit fares (e.g., pricing for each of the different passes, etc.), locations of ticketing systems, transit alerts, etc.

The transit data may be accessed by the engine 118 as desired, for example, by retrieving appropriate information from the transit merchant's website or application, or by the API available from the transit merchant 102. The accessed transit data may include only the transit data associated with the desired time interval of the corresponding calendar data accessed by the engine 118, or it may include all transit data for a specific region (e.g., a region generally associated with the consumer 114 such as a home region set by the consumer 114 as a preference, a region generally associated with a current location of the consumer's portable communication device 116, a region generally defined by locations included in the calendar data, etc.), or it may include a more general category of transit data.

After accessing the calendar data and the transit data, the engine 118 initially generates a travel plot for the consumer 114 based on the calendar data. The travel plot includes necessary travel, for example, a route, etc., from a starting location, or more generally a prior location, of the consumer 114 (e.g., a home location, an office location, a prior meeting location, etc.), to each location indicated by the calendar data for the desired travel interval of accessed calendar data. Or, the travel plot may be generated based on a calendar for a subinterval of the desired travel interval, as subsequently identified by the consumer 114. The travel plot may be as simple as travel from home to work and from work to home, each day over the time interval, or it may be more complex to accommodate multiple meetings away from the consumer's office, home, etc.

The travel plot is used by the engine 118 to identify (or determine) purchase options for the consumer 114 for travel, that satisfies the requirements of the travel plot. In generating the purchase options, the engine 118 may use (or include) different types of travel passes to provide various pricing options for the consumer 114, i.e., different fare options. The engine 118 may also take into account different travel routes and/or different transit modes to provide different purchase options. In addition, the engine 118 may take into account various user preferences (e.g., preferred transit modes, preferred routes, etc.), predicted weather conditions or predicted travel conditions for segments of the travel plot (e.g., to/from a particular location in the travel plot, etc.), and even historical purchases indicated by transaction data (to the consumer's payment account) in identifying different purchase options. Once the purchase options are identified, the engine 118 displays them to the consumer 114, at presentation unit 206 of the communication device 116.

In turn, the consumer 114 can select one of the purchase options identified by the engine 118, for example, an option having the lowest total fare, and proceed to purchase the option. For example, the engine 118 may call the API associated with the transit merchant 102, and provide the necessary details of the selected purchase option (e.g., corresponding travel pass or passes associated therewith) to be purchased. The engine 118 may then provide payment information to the transit merchant 102 to facilitate the purchase transaction (as generally described above). Upon completion of the purchase transaction, the travel details of the selected travel (e.g., travel passes associated with the selected travel, etc.), and/or a receipt identifying the purchase transaction may be displayed to the consumer 114 at the presentation unit 206.

It should be appreciated that the selection engine 118 may provide purchase options to the consumer 114 in response to a request by the consumer 114. Or, the engine 118 may provide purchase options to the consumer 114 at its own initiative (e.g., at predetermined intervals, when it determines that travel from previously purchased options is running out or is expiring or may not cover future travel suggested by the consumer's calendar, etc.).

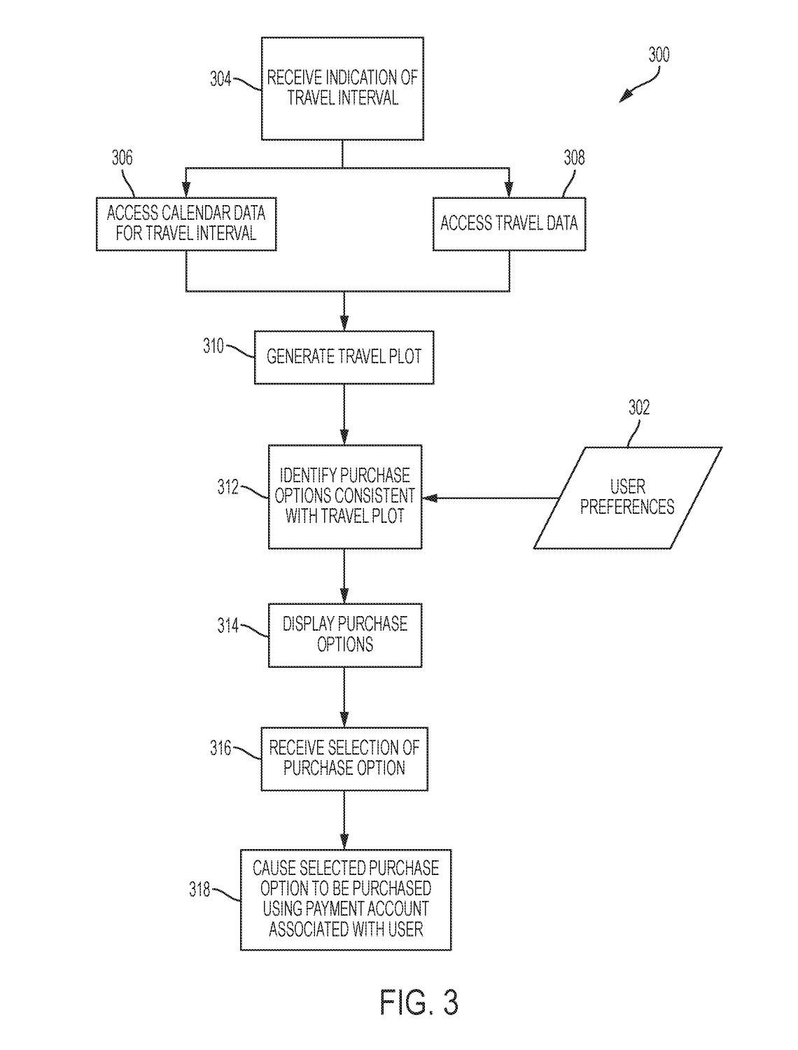

FIG. 3 illustrates an exemplary method 300 for identifying purchase options for travel for a consumer, based on calendar data associated with the consumer. The exemplary method 300 is described as implemented in the selection engine 118 of the portable communication device 116 associated with consumer 114. However, it should be understood that the method 300 is not limited to the selection engine 118, or the portable communication device 116, as it may be implemented in other ones of the computing devices 200 in system 100, or in other computing devices. For example, the methods 300 may be implemented, at least in part, within the transit merchant 102. Nonetheless, the methods herein should not be understood to be limited to the exemplary system 100 or the exemplary computing device 200, and the systems and the computing devices herein should not be understood to be limited to the exemplary method 300.

Initially in the method 300, the consumer 114 registers for use of the engine 118, or otherwise accesses the engine, for example, by installing an application associated with the engine 118 on the consumer's portable communication device, etc. In so doing, the engine 118 provides an interface through which the consumer 114 can provide multiple preferences to the engine 118 (e.g., user preferences, etc.), via inputs to the portable communication device 116, for subsequent use by the engine 118 when identifying purchase options for the consumer 114, as described next. In turn, the engine 118 receives the preferences, when provided, and stores them in a data structure 302 associated with memory 204 of the consumer's portable communication device 116. As such, the preferences are available to the engine 118 when needed, and without the consumer 114 having to continuously provide them. Further, the preferences can be updated by the consumer 114 as desired. In various embodiments, the consumer 114 also provides permission to the engine 114 at this time (or later) to access the consumer's calendar, for use in the method 300 as described herein.

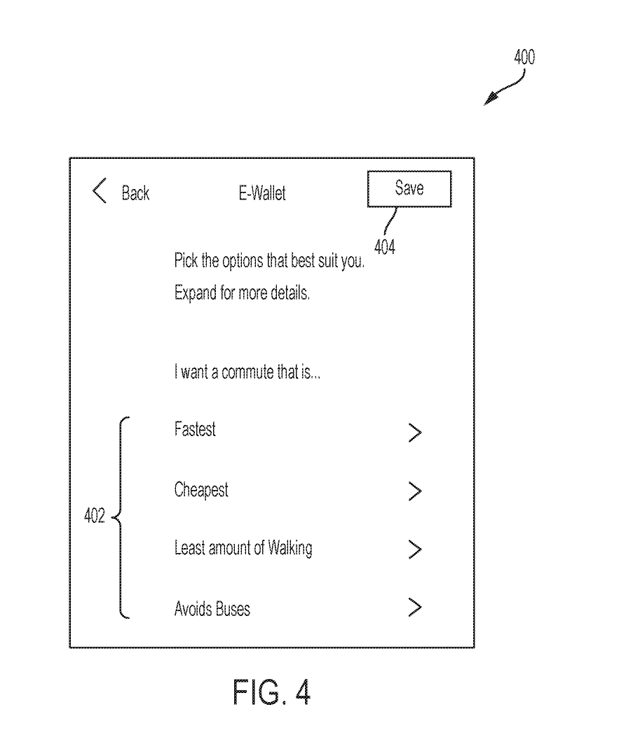

FIG. 4 illustrates an exemplary interface 400 that may be provided from the engine 118, to solicit preferences from the consumer 114. As shown, in the interface 400, the consumer 114 has multiple options 402 (that include various predefined available selections) from which the consumer 114 can select preferences related to travel duration (e.g., identify purchase options with the “Fastest” travel durations, etc.), travel cost (e.g., identify purchase options having the “Cheapest” travel fares, etc.), and transit mode (e.g., identify purchase options with the “Least amount of Walking” and “Avoid Busses,” etc.). Once selected, the preferences can be saved via button 404 and then employed by the engine 118 as described herein (e.g., in connection with accessing calendar data, accessing transit data, identifying purchase options for the consumer 114; etc.). It should be appreciated that different interfaces may be used to solicit these preferences from the consumer 114 (with preferences being either predefined or provided as free-form text), and that different categories of preferences may be solicited from, or provided by, the consumer 114.

Once the engine 118 is available to the consumer 114, it can be used at the consumer's portable communication device 116 to identify available purchase options for a desired interval. For example, at the beginning of a week, or a month, or another time interval (or, in general, when desired), the consumer 114 may access (e.g., sign in, etc.), or otherwise invoke, the engine 118 to find purchase options for needed travel. In connection therewith, the consumer 114 provides the desired interval to the engine 118, which may be a default interval (e.g., set as a preference for the consumer 114, etc.) or a selected interval (e.g., a selected date or date range, etc.) particular to upcoming travel needs. Or, based on the consumer's calendar, the engine 118 may suggest to the consumer 114 that travel may be needed in an upcoming interval. In any case, the interval generally defines the time range over which the consumer 114 needs to travel and over which the engine 118 defines, or identifies, available purchase options for the consumer 114. In various embodiments, the engine 118 may display an interface to the consumer 114 soliciting a date or range of dates for travel, in response to which the consumer 114 enters the desired interval.

In turn, the engine 118 receives the interval, at 304. When the interval includes a default interval, the engine 118 may retrieve the interval from memory 204 as part of receiving the interval. Alternatively, when the interval includes an interval specified by the consumer 114, the engine 118 receives the interval from the consumer, 114, via the portable communication device 116, and then stores it in memory 204.

Upon receiving the interval identifying the time over which the consumer 114 needs to travel, the engine 118 accesses, at 306, calendar data for the consumer 114 based on the interval. As previously described, the calendar data may be stored in memory 204 of the portable communication device 116. Or, the portable communication device 116 may include a calendar application, stored in part or in total in memory 204 of the portable communication device 116 or in a companion computing device, associated with calendar and/or email features of the portable communication device 116 (e.g., Outlook® manager, or other personal information manager, etc.). As previously described, in various embodiments, the consumer 114 provides particular permission to the engine 118 to access his/her calendar.

Separately, at 308, the engine 118 accesses transit data from the transit merchant 102, for example, from a transit data structure associated with the merchant 102, for use in identifying available travel for the consumer 114 over the interval. In particular in the method 300, the engine 118 accesses transit data specific to the consumer's interval for travel and, in particular, transit data specific to the locations and times indicated by the consumer's calendar data for the interval. In at least one embodiment, the engine 118 also accesses transit data for times beyond the interval. Specifically, for example, a monthly pass may be more efficient than a weekly pass, even when the consumer 114 has selected to find a purchase option only for a one-week interval. Further, in some embodiments, the engine 118 may access the transit data based on one or more of the consumer's predefined preferences. For example, if a consumer 114 prefers to avoid busses, the engine 118 may forgo accessing transit data relating to bus schedules and/or fares, i.e., transit data relating to bus travel. It should be appreciated that any relevant transit data may be accessed, by the engine 118, based on a variety of different factors associated with the consumer 114, the consumer's calendar data, etc. In the method 300, the transit data is accessed via an API to the transit merchant 102. However, the transit data could be accessed differently in other embodiments.

Table 1 illustrates exemplary travel passes and associated fares offered by the transit merchant 102 for travel from Location A to Location B.

TABLE 1

| Available Travel Pass from | |
|---|---|
| Location A to Location B | Fair |
| Peak one way | $13.78 |
| Off peak one way | $10.45 |
| Weekly | $94.29 |
| Off peak 10 trip | $88.83 |
| Monthly | $303.8 |

Once the calendar data and the transit data are accessed, the engine 118 generates (or determines) a travel plot for the consumer 114, at 310, based on the calendar data for the specified interval. The travel plot includes a compilation of travel segments necessary for the consumer 114 to be at each location from the accessed calendar data at the required time. For example, for a one day interval, when the consumer 114 travels from home to his/her office in the morning and then back home after work at the end of the day (e.g., as a default entry, as a specific calendar entry, etc.), the travel plot for the day may include two segments: a segment comprising travel from home to work, and a segment comprising travel from work to home. If the consumer 114 also has a meeting that day away from his/her office, two additional segments may be added to the travel plot for the day: a segment comprising travel from work to a location of the meeting, and a segment comprising travel from the meeting location back to work. Thus, as the number of appointments or other travel requirements (with different locations) increases for the day, the number of segments in the consumer's travel plot increases. This similarly applies to travel plots based on longer intervals.

Then, at 312, the engine 118 identifies purchase options for the consumer 114 consistent with the travel plot. In this embodiment, the purchase options each include different travel passes from the transit merchant 102 for the consumer 114 to permit travel along each segment of the travel plot, as well as a fare associated with each travel pass, one or more discounts available from the transit merchant, and a total fare for each purchase option. For a travel plot spanning a one-week interval, the purchase options may include, for example, an unlimited weekly train pass, a five-ride train pass, five daily train passes, a term bus pass, some other pass for transit, a combination of such passes, etc.

In connection with identifying the purchase options for the consumer 114, the engine 118 may take into account the preferences received from the consumer 114, and stored in the data structure 302, to select or exclude various ones of the options prior to presenting them to the consumer 114. The preferences, as indicated above, may include a variety of preferences for the consumer 114 related to travel. If, for example, a preference from the consumer is for a cheapest fare (potentially based on one or more discounts from the transit merchant), the engine 118 may discard all purchase options except for the one with the cheapest fare. In another example, if a preference from the consumer is for shortest travel, the engine 118 may discard all purchase options except for the one with the shortest travel time and/or the one with the shortest travel distance. In still another example, if a preference from the consumer is to exclude bus travel, the engine 118 may discard all purchase options requiring travel by bus and then present the remaining options to the consumer 114.

In addition, the engine 118 may also access various other factors that can affect purchase options for the consumer 114 and be used, for example, to filter the options prior to displaying them to the consumer 114.

One such factor includes weather data associated with the generated travel plot. For example, the consumer 114 may indicate a preference to walk between certain locations or as part of certain travel segments of the travel plot. In response, the engine 118 may identify certain segments of the travel plot that the consumer 114 can walk (e.g., segments that are less than one mile, etc.). In particular, the engine 118 may access weather data for the travel plot, and specifically the identified walking segments thereof, to ensure there is no rain in the forecast (or that rain is not likely) and that the temperature is suitable to walk (e.g., between 55° F. and 85° F., etc.) for the times the consumer 114 will be in transit.

Another such factor includes traffic conditions, for example, construction zones, etc., along segments of the travel plot. Here, the engine 118 may identify certain segments of the travel plot (specifically, available routes for such segments) that have construction activity, and exclude purchase options including the construction routes (as the construction activity may unexpectedly delay travel along the routes).

It should be appreciated that other factors may further be employed to help identify or exclude purchase options for the consumer 114 in similar manners. Example additional factors include, without limitation: location(s) associated with the travel plot, which may be used to indicate travel safety for the consumer 114, terrain, etc.; time of day of travel (e.g., night, day, etc.); day of year for travel (e.g., weekday, weekend, holiday, etc.); etc.

Table 2 illustrates exemplary purchase options identified by the engine 118, for example, for four different consumers A-D each having different calendar schedules and travel requirements. Despite the specific options included in Table 2, it should be appreciated that various other options may be created, or identified, for the consumer 114 and/or for other consumers, for example, based on the travel plot and/or segments therein for each of the consumers.

As shown in Table 2, consumers A and B each have particular travel requirements over the next month. Calendar data for consumer A, as accessed by the engine 118, indicates that consumer A needs to travel to/from work for 22 days in the coming month, with all travel occurring during peak travel times. Consumer A also has a preference for the cheapest purchase option. In view of the fares listed in Table 1, the purchase option identified by the engine 118 for consumer A includes a monthly pass, with a total fare of $303.80. Calendar data for consumer B, as accessed by the engine 118, indicates that consumer B needs to travel ten days in the next month, with ten peak-time trips and ten off peak-time trips. In response, the engine 118 identifies two purchase options for consumer B. Option 1 includes separate individual passes for each segment of the travel plot, i.e., 10 peak passes and 10 off-peak passes, with a total fare of $242.30. Conversely, Option 2 includes 10 individual peak passes and an off-peak 10-ride pass, with a total fare of $226.63.

As also shown in Table 2, consumers C and D each have particular travel requirements over the next week. Calendar data for consumer C, as accessed by the engine 118, indicates that consumer C needs to travel three days in the next week, all of which are at peak times. In response, the engine 118 identifies two purchase options for consumer C. Option 1 includes a weekly peak pass having a total fare of $94.29, and Option 2 includes six individual peak passes (one each way) having a total fare of $82.68. Calendar data for consumer D, as accessed by the engine 118, indicates that consumer D needs to travel four days in the coming week, with peak-time travel going from home to work and off-peak time travel going from work back home. In response, the engine 118 identifies three purchase options for consumer D. Option 1 includes a weekly pass having a total fare of $94.29; Option 2 includes four peak passes and four off-peak pass having a total fare of $96.92; and Option 3 includes four peak tickets and four uses of a 10-trip off-peak pass having a total fare of $90.65.

TABLE 2
Consumer A: Commutes 22 days/month, peak hours

| | | |
|---|---|---|
| Option 1 | Monthly pass | $303.80 |

Consumer B: Commutes 10 days/month (10 peak trips, 10 off peak)

| | | |
|---|---|---|
| Option 1 | 10 peak passes | $137.80 |
| | 10 off peak passes | $104.50 |
| | Total | $242.30 |
| Option 2 | 10 peak passes | $137.80 |
| | Off peak 10 trip pass | $88.83 |
| | Total | $226.63 |

Consumer C: Commutes 3 days this week, all at peak times

| | | |
|---|---|---|
| Option 1 | Weekly pass | $94.29 |
| Option 2 | 6 peak passes | $82.68 |

Consumer D: Commutes 4 days this week, returns off peak

| | | |
|---|---|---|
| Option 1 | Weekly pass | $94.29 |
| Option 2 | 4 peak passes | $55.12 |
| | 4 off peak passes | $41.80 |
| | Total | $96.92 |
| Option 3 | 4 peak passes | $55.12 |
| | 4 uses of 10-trip off peak pass | $35.53 |
| | Total | $90.65 |

With continued reference to FIG. 3, after the purchase options are identified, the engine 118 displays (broadly, publishes) the options to the consumer 114, at 314, for example, at presentation unit 206 of portable communication device 116. In response, the consumer 114 can then select, and purchase, one (or potentially multiple ones) of the displayed purchase options at the portable communication device 116, by which the engine 118 receives the selection of the purchase option, at 316.

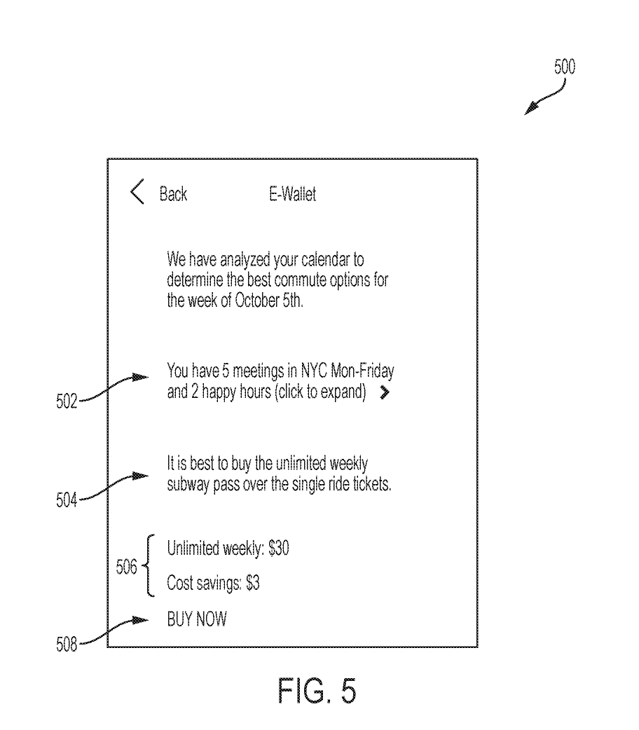

FIG. 5 illustrates an exemplary interface 500, by which the consumer 114 may be informed of purchase options identified by the engine 118 and purchase select ones of the options. In this example, the interface 500 includes a summary 502 of the consumer's travel requirements for the given period, i.e., Monday-Friday in the example, one purchase option 504, and pricing 506 for the option (along with cost savings over the next cheapest purchase option). The interface 500 then also includes an option 508 for the consumer 114 to select, or “Buy Now”, the identified purchase option 504.

When the consumer 114 selects one of the identified purchase options, the engine 118 receives the selection, at 318. The engine 118 then causes the selected option (e.g., travel passes associated with the selected option, etc.), to be purchased, via the consumer's payment account.

For example, the communication device 116 may include a payment application (e.g., an e-wallet, etc.), with payment account information for the consumer 114. As such, upon receiving the selection, the engine 118 calls to an API associated with the transit merchant 102, or other portal or access point for the transmit merchant 102 (e.g., a website or web-based application, etc.), and then populates the appropriate information to the transit merchant 102 to cause the selected option to be purchased. The engine 118 may provide payment information to the transit merchant 102 to facilitate the purchase transaction (as generally described above). A purchase confirmation interface and/or receipt may then display at the communication device 116 for review by the consumer 114. In some embodiments, the consumer's communication device 116 may further act, or function, as the travel pass through display of a symbol such as, for example, a barcode or QR code, that can be scanned upon the consumer's entry to the particular travel means associated with the purchased pass (e.g., bus, train, etc.), or to be viewed by an employee associated with the transit merchant 102 to permit access thereto, etc.

The systems and methods herein can provide consumers with more efficient and/or effective commutes, based on their preferences. For example, by analyzing transaction history and calendar information for consumers, the systems and methods herein are able to recommend what travel and/or how much fare the consumer should add to existing travel wallets. As such, the consumers can purchase travel that is right/best for them, and that is customized to their particular needs and preferences. What's more, the consumers can make the purchases at any time (e.g., while in transit, while at home, while at work, etc.). In addition, by analyzing other data such as transit schedules, status (including delays) and weather, the systems and methods can notify consumers of delays, times, and tracks, and recommend specific routes and schedules, and even suggest the consumer pack an umbrella (if rain is forecast) or wear particular clothes (e.g., if delays are predicted or the route involves a lot of walking).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing calendar data for a user, the calendar data including a location and a time for at least one appointment for the user; (b) identifying a first purchase option including travel from a prior location to the location of the at least one appointment, so that the user is scheduled to arrive at the location of the at least one appointment prior to the time for the at least one appointment; (c) identifying a second purchase option including travel, different than the travel of the first purchase option, from the prior location to the location of the at least one appointment, so that the user is scheduled to arrive at the location of the at least one appointment prior to the time for the at least one appointment; (d) determining a fare associated with each of the first and second purchase options; (e) receiving a selection of at least one of the first and second purchase options; and (f) publishing the selected at least one of the first and second purchase options.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying effective purchase options for travel, the method comprising:
accessing, by a computing device, calendar data for a user, the calendar data including a location and a time for at least one appointment for the user;
identifying, by the computing device, a first purchase option including travel from a prior location to the location of the at least one appointment, so that the user is scheduled to arrive at the location of the at least one appointment prior to the time for the at least one appointment;
identifying, by the computing device, a second purchase option including travel, different than the travel of the first purchase option, from the prior location to the location of the at least one appointment, so that the user is scheduled to arrive at the location of the at least one appointment prior to the time for the at least one appointment;
determining, by the computing device, a fare associated with each of the first and second purchase options;
receiving, at the computing device, a selection of at least one of the first and second purchase options; and
publishing, by the computing device, the selected at least one of the first and second purchase options.

2. The method of claim 1, further comprising accessing, by the computing device, a travel data structure, the travel data structure including travel schedules for at least one mode of transit in a region associated with a location of the at least one appointment included in the calendar data.

3. The method of claim 2, wherein identifying the first purchase option includes identifying the first purchase option based on at least one of a preference provided by the user related to a mode of transit and a weather condition for the region associated with the location of the at least one appointment included in the calendar data.

4. The method of claim 3, wherein a travel plan associated with the first purchase option and a travel plan associated with the second purchase option overlap in part.

5. The method of claim 4, wherein the first purchase option includes a term-pass option, and wherein the second purchase option includes a pass-per-purchase option.

6. The method of claim 1, wherein publishing the selected at least one of the first and second purchase options includes populating a purchase interface associated with a transit merchant for purchase of travel included in the selected at least one of the first and second purchase options.

7. A non-transitory computer readable storage media including executable instructions for detecting effective travel purchases that, when executed by at least one processor, cause the at least one processor to:
access calendar data for a user, the calendar data including one or multiple appointments for the user over a predetermined interval, each of the one or multiple appointments including a location;
access a travel data structure, the travel data structure including multiple transit options and associated fares for travel in at least one region associated with locations of each of the one or multiple appointments for the user;
identify at least one purchase option for the user including travel from a prior location to the location of each of the one or multiple appointments for the user, the at least one purchase option including a total fare for travel to the one or multiple appointments; and
cause the at least one purchase option to be displayed.

8. The non-transitory computer readable storage media of claim 7, wherein the at least one purchase option includes a first purchase option; and
wherein the executable instructions, when executed by at least one processor, further cause the at least one processor to cause a purchase transaction, to a payment account associated with the user, for the first purchase option, in response to a purchase input from the user for the first purchase option.

9. The non-transitory computer readable storage media of claim 7, wherein the at least one purchase option includes a first purchase option and a second purchase option, the first purchase option including a different total fare for travel to the one or multiple appointments for the user than the second purchase option; and
wherein the executable instructions, when executed by the at least one processor, further cause the at least one processor to receive a selection of the first and/or second purchase option from the user.

10. The non-transitory computer readable storage media of claim 9, wherein the first purchase option includes a pass to a first mode of transit and a pass to a second mode of transit different from the first mode of transit.

11. The non-transitory computer readable storage media of claim 9, wherein the executable instructions, when executed by the at least one processor, further cause the at least one processor to:
cause a purchase transaction, to a payment account associated with the user, for the first purchase option, in response to a purchase input from the user for the first purchase option; and
cause a purchase transaction, to a payment account associated with the user, for the second purchase option, in response to a purchase input from the user for the second purchase option.

12. The non-transitory computer readable storage media of claim 7, wherein the executable instructions, when executed by the at least one processor, further cause the at least one processor to:
receive a user preference; and
identify the at least one purchase option based, at least in part, on the user preference.

13. The non-transitory computer readable storage media of claim 12, wherein the executable instructions, when executed by the at least one processor, further cause the at least one processor to:
access weather data indicative of at least one weather condition for a travel time between a prior location and a location included in at least one of the one or multiple appointments; and
identify the at least one purchase option based, at least in part, on the at least one weather condition.

14. The non-transitory computer readable storage media of claim 12, wherein the user preference defines at least one of a preferred mode of transit, a preferred route, and a preferred purchase interval.

15. The non-transitory computer readable storage media of claim 7, wherein the prior location is a location included in a prior one of the one or multiple appointments.

16. The non-transitory computer readable storage media of claim 7, wherein the prior location is a business address of the user or a home address of the user.

17. A fare selection computing device, comprising:
a memory including at least one user preference;
a presentation device; and
at least one processor coupled to the memory and the presentation device and configured, by executable instructions, to:
access calendar data for a user, the calendar data including multiple appointments within a defined interval, each of the appointments associated with a location and a time;
access travel data from a data structure associated with a transit merchant for at least the defined interval;
generate a travel plot including travel to the location of each of the multiple appointments from the calendar data;
identify multiple travel options for the user based on the travel plot, each of the multiple travel options associated with a total fare; and
display the multiple travel options and associated total fares at the presentation device.

18. The computing device of claim 17, wherein the at least one processor is further configured, by executable instructions, to publish the purchase option to a purchase interface associated with the transit merchant.

19. The computing device of claim 18, wherein the at least one processor is further configured, by executable instructions, to generate a purchase transaction for at least one of the multiple purchase options.

20. The computing device of claim 17, wherein the at least one processor is further configured, by executable instructions, to identify the purchase option based on at least one discount available from the transit merchant.
